(19) United States
(12) Patent Application Publication
(10) Pub. No.: US 2006/0269050 A1
(43) Pub. Date: Nov. 30, 2006

(54) Adaptive fraud management systems and methods for telecommunications

(75) Inventors: Sudeesh Yezhuvath, Bangalore (IN); Dakshinamurthy Karra, Bangalore (IN)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Subex Systems Limited

(21) Appl. No.: 11/136,553

(22) Filed: May 25, 2005

(51) Int. Cl. H04M 15/00

(52) U.S. Cl. 379/114.01; 707/101

(57) ABSTRACT

Methods and systems for detecting telecommunications fraud in a telecommunications network are disclosed. Such methods and systems are capable of economically detecting telecommunications fraud for individual subscribers of a telecommunications provider by virtue of an adaptive fraud detection engine that adapts based on telecommunications traffic particular to each subscriber.

### FIELD OF THE INVENTION

This disclosure relates to a computer-based systems for detecting telecommunications fraud.

### BACKGROUND OF THE INVENTION

Telecommunications fraud is perhaps the biggest threat to a telecommunications company in today's market. The International Forum of Irregular Network Access (FIINA), a leading Fraud and Security industry association, estimates a figure for global telecommunications fraud of $60 billion per year, and believes that operators lose as much as 6% of their annual revenue to fraud. Further, FIINA expects those figures to rise with the growing use of next-generation wireless and IP services.

While a number of anti-fraud detection techniques and devices have evolved to counter the problem, such techniques and devices have a number of drawbacks. For example, successful management of telecommunications fraud using conventional approaches requires a fraud monitoring entity to accurately monitor customer usage in order to detect suspicious activity patterns indicative of fraud.

To date, the fraud-detection community has approached these tasks by splitting a telecom provider's subscriber base into multiple groups based on different categories. For example, customers can be categorized as new subscribers, managers, VIPs, by region, by particular service, etc. Rules and thresholds are defined and set for individual groups, and all subscribers within a group will inherit the fraud models and thresholds for that group.

Unfortunately, increasing fraud-detection accuracy using the above-described approach requires an increase in the number of groups, which has the consequence of increasing the cost of fraud monitoring. Accordingly, new methods and systems capable of providing more accurate and low-cost telecommunications fraud services are desirable.

### SUMMARY OF THE INVENTION

In one aspect, an apparatus for detecting telecommunications fraud in a telecommunications network includes a receiving device that receives telecommunications traffic information relating to one or more subscribers of a telecommunications provider, and a fraud detection engine that determines whether telecommunications fraud has occurred based upon the received telecommunications traffic information, wherein the fraud detection engine uses an adaptive process to determine fraud.

In a second aspect, a method for detecting telecommunications fraud in a telecommunications network includes receiving a plurality of first telecommunications traffic records relating to one or more subscribers of a telecommunications provider, and performing a fraud detection operation on the first telecommunications traffic records using an adaptive fraud detection process.

In a third aspect, a method for detecting telecommunications fraud in a telecommunications network includes receiving a plurality of telecommunications traffic records relating to a plurality of subscribers of a telecommunications provider, and performing a fraud detection operation on each of the plurality of subscribers using a respective combination of a fraud detection model and threshold paradigm selected for each subscriber, where each of the respective combinations includes at least one adaptive component, and where the adaptive component for each particular subscriber is updated based on telecommunications traffic records specifically relating to the particular subscriber's usage.

In a fourth aspect, an apparatus for detecting telecommunications fraud in a telecommunications network includes a storage device containing a plurality of telecommunications traffic records relating to one or more subscribers of a telecommunications provider, and an adaptive fraud detection means for adaptively detecting telecommunications fraud based on the telecommunications traffic records.

In a fifth aspect, a storage medium includes a first set of one or more instructions configured to receive a plurality of telecommunications traffic records relating to a plurality of subscribers of a telecommunications provider, and a second set of one or more instructions configured to perform a fraud detection operation on each of the plurality of subscribers using a respective combination of a fraud detection model and threshold operator selected for each subscriber, wherein each of the respective combinations includes at least one adaptive component, wherein the adaptive component for each particular subscriber is updated based on telecommunications traffic records specifically relating to the particular subscriber's usage.

In a sixth aspect, a storage medium includes an apparatus for detecting telecommunications including a fraud detection engine having at least a first fraud detection model suitable for detecting at least one form of telecommunications fraud and at least one respective adaptive threshold paradigm, wherein the fraud detection engine is configured to apply the first fraud detection model to a group of subscribers of the telecommunications provider, but wherein at least two subscribers are assigned different respective adaptive threshold paradigms having different adapted weights.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a generalized view of an exemplary telecommunications network.

FIG. 2 is an exemplary telecommunications provider for the network of FIG. 1.

FIG. 3 is an exemplary fraud management system capable of monitoring subscriber activity.

FIG. 4 depicts an exemplary telecommunications fraud model.

FIG. 5 depicts an exemplary adaptive threshold.

FIG. 5B depicts an exemplary adaptive threshold with biasing.

FIG. 6 is a flowchart outlining an exemplary method for adaptive fraud detection.

### DETAILED DESCRIPTION

In the world of telephony, there exists a multitude of opportunities for fraud. Various types of telephony fraud are typically referred to by the names: Subscription Fraud, Clip-on, Clip-on to Payphone, Payphone Meter Pulse Defeat, Collect Calls to Call Office, Booked Calls from Call Office, Stolen Line Unknown, MSISDN/IMSI Pair, Call Forwarding Manipulation, Call Back, Operators Conference Call Manipulation, International Roaming Manipulation, SIM Cloning and Premium Rate Service Fraud. Other types of network fraud applicable to this disclosure include various non-telephony (e.g., internet) schemes, such as Electronic Banking and Payment Fraud, Illegal Downloading and Distribution of Digital Content, “Phishing” for private information and Modem Hijacking. While the lists above appear to be extensive, it should be appreciated that these lists represent but a fraction of known and potential fraud schemes. Accordingly, the following discussion shall be limited to generalized fraud in a telephony environment for simplicity of explanation, but it should be appreciated that the following disclosure nonetheless shall be generally applicable to all types of telecommunications fraud.

For the purpose of this disclosure, the term “adaptive” shall refer to systems capable of updating one or more weights based on ongoing traffic. Generally, such adaptive systems known in the art can include adaptive linear combiners, adaptive filters, artificial neural networks, heuristic algorithms and artificial intelligence systems. However, it should be appreciated that any form of adaptive technology can alternatively be used as may be advantageous. For example, by determining a parameter based upon the “mean value” of all data received in the past three hours, that parameter in essence is adapted to its environment.

Additionally, the term “continuously adaptive” shall refer to adaptive systems that are periodically updated. For example, in the “mean value” example directly above, by periodically re-evaluating the parameter based upon a rolling average of data continuously received, the re-evaluated parameter can be considered to be “continuously adapted”. In contrast, an artificial neural network can be considered “adaptive”, but not “continually adaptive” if the synaptic weights of the artificial neural network are never updated after being initially set.

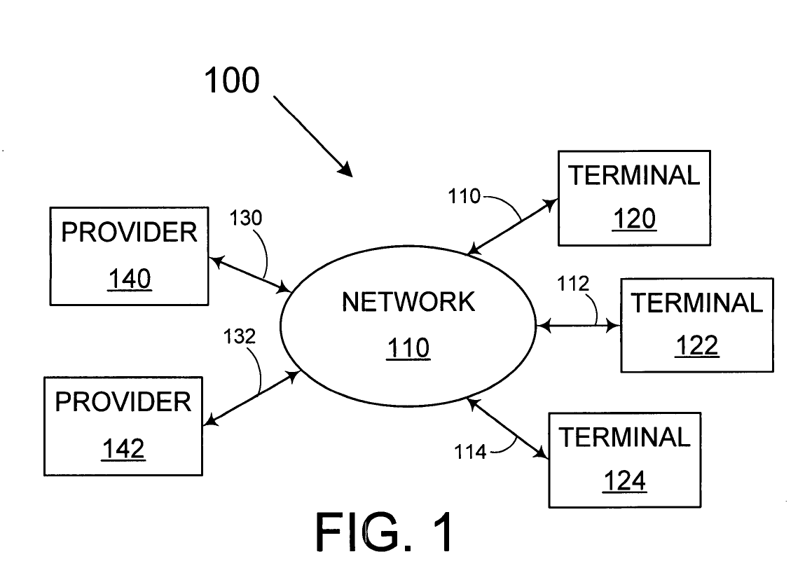

FIG. 1 depicts an exemplary networked-system 100 configured to provide telecommunications services and enable a provider of fraud detection equipment and services to detect telecommunications fraud as it occurs on the networked-system 100. As shown in FIG. 1, the networked-system 100 includes a number of providers 140-142 coupled to a network 102 via links 130-132, as well as a number of terminals 120-124 coupled to the network 100 via respective links 110-114.

In operation, the providers 140-142 can each host a number of subscribers, i.e., a subscriber being a subscriber of a provider and generally willing to pay such provider to use the provider's telecommunications equipment. In turn, the subscribers can provide telecommunications services to various individuals and companies via the terminals 120-124. For example, in a particular embodiment provider 140 can be an owner of long-distance telephony equipment having a number of subscribers that sell long-distance services via pre-paid cards. The cards can be purchased by individuals who then gain long-distance access by the network 102 using predetermined codes printed on the cards.

During operation, various fraud management systems (not shown) located at the providers 140-142 and equipped with a host of monitoring systems can monitor and store various telecommunications information of interest, then perform various processes on the information to assess whether a user at one of the terminals 120-124 and/or a subscriber is attempting to engage in fraud. Upon detecting fraud, a provider can then apply a host of remedies from fining a user and/or subscriber to immediately cutting off service to initiating civil or criminal complaints.

The terminals 120-122 of the immediate example are telephone systems capable of interfacing with a public telephony exchange. However, in various embodiments the terminals 120 can include any of a variety of communication devices, such as personal computers, PDAs, telephones and cell-phones (with and without graphic displays), television sets with special two-way interfaces or any other known or later-developed communication device capable of communicating over a communication network without departing from the spirit and scope of the present disclosure.

The exemplary providers 140-142 are a combination of dedicated telephony circuits and systems coupled to a variety of servers and monitoring equipment. However, as with the terminals 120-124, it should be appreciated that the provider 130 can take any number of forms without departing from the spirit and scope of the present disclosure.

The exemplary network 102 is a public telephony exchange. However, in other embodiments the network 102 can be any viable combination of devices and systems capable of linking computer-based systems including a wide area network, a local area network, a connection over an intranet or extranet, a telephony network, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a telephony-based system including T1 and E1 devices, a wired system, an optical system, a wireless system and so on.

The various links 110-114 and 130-132 of the present embodiment are a combination of telephonic devices and software/firmware configured to couple telephony systems to a telephony exchange. However, it should be appreciated that, in differing embodiments, the links 110-114 and 130-132 can take the forms of modems, networks interface card, serial buses, parallel busses, WAN or LAN interfaces, subscriber's line interfaces, T1 interfaces, E1 interfaces, wireless or optical interfaces and the like as may be desired or otherwise dictated by design choice.

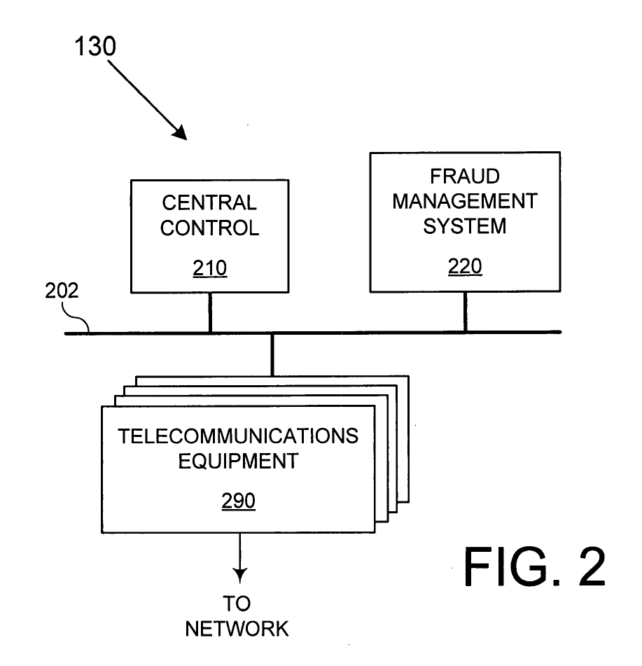

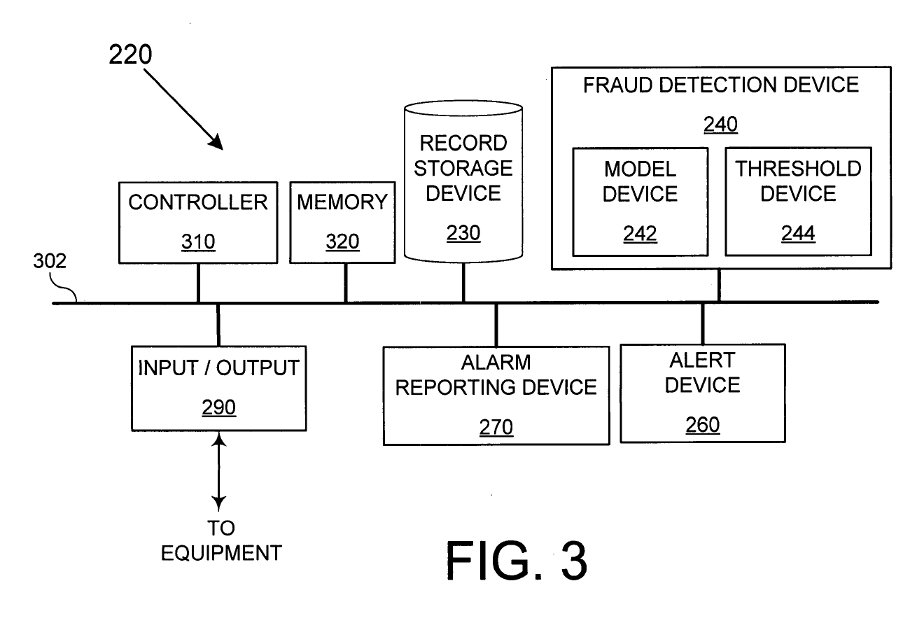

FIG. 2 depicts an exemplary telecommunications provider 140. As shown in FIG. 3, the exemplary provider 140 includes a central control device 210, a fraud management system 220 and a bank of telecommunications equipment 290. The above components 310-390 are coupled together by control/data network 302.

In operation, the central control device 210 can be used to configure the telecommunications equipment 290 as well as monitor ongoing activity of the telecommunications equipment 290. Concurrently, the fraud management system 220 can also monitor the telecommunications equipment 290 in order to determine whether any ongoing fraud can be detected. Upon detecting one or more instances of fraud, the fraud management system 220 can send a signal to the central control device 210. In response, the central control device 210 can apply any number of remedies, such as cut off any offending telecommunications transaction mid-stream, more closely monitor the offending telecommunications transaction to compile incriminating records, and so on.

FIG. 3 is an exemplary fraud management system 220 capable of monitoring telecommunications activity on a telecommunications network and determining whether any fraud is occurring on the telecommunications network. As shown in FIG. 3, the exemplary provider 220 includes a controller 310, a memory 320, a record storage device 330, a fraud detection engine 340 having a model device 342 and a threshold device 344, an alert device 360, an alarm reporting device 370 and an input/output device 390. The above components 310-390 are coupled together by control/data bus 302.

Although the exemplary fraud management system 220 uses a bussed architecture, it should be appreciated that any other architecture may be used as is well known to those of ordinary skill in the art. For example, in various embodiments, the various components 310-390 can take the form of separate electronic components coupled together via a series of separate busses.

Still further, in other embodiments, one or more of the various components 310-390 can take form of separate servers coupled together via one or more networks. Additionally, it should be appreciated that each of components 310-390 advantageously can be realized using multiple computing devices employed in a cooperative fashion. For example, by employing two or more separate computing devices, e.g., servers, to provide for the fraud detection engine 240 for each alert device 260, a processing bottleneck can be reduced/eliminated and the overall computing time to monitor fraud can be reduced.

It also should be appreciated that some of the above-listed components can take the form of software/firmware routines residing in memory 320 and be capable of being executed by the controller 310, or even software/firmware routines residing in separate memories in separate servers/computers being executed by different controllers. Further, it should be understood that the functions of any or all of components 340-270 can be accomplished using object-oriented software, thus increasing portability, software stability and a host of other advantages not available with non-object-oriented software.

Before fraud detection operations begin, an operator using the fraud management system 220 can first decide the appropriate fraud detection model appropriate for a type of fraud of interest and/or a particular subscriber to install in the model device 242, as well as decide the appropriate threshold paradigm to install in the threshold device 344.

In various embodiments, the fraud model can take any number of non-adaptive, adaptive and continuously adaptive forms. When adaptive or continuously adaptive systems are employed, such systems can take the form of various known combination of techniques, such as those described above. However, it should be appreciated that any form of adaptive technology can alternatively be used as may be advantageous.

Similarly, in various embodiments, the threshold paradigm can take any number of non-adaptive, adaptive and continuously adaptive forms. When adaptive or continuously adaptive systems are employed, such systems can take any combination of known or later developed adaptive paradigms or can simply take the form of a single adaptable threshold parameter.

After the appropriate fraud model and threshold paradigm are selected for a particular subscriber or group of subscribers, the operator can perform an initial training/adaptation of the various adaptive parameters employed using actual telecommunications records of a respective subscriber or using records of similar entities.

Once the appropriate fraud model and threshold paradigm are selected and initially trained/adapted (when applicable), the fraud management system 220 can receive a number of telecommunications records from external monitoring devices and store the telecommunications records in the record storage device 330.

Subsequently, the fraud detection engine 220 can select related telecommunications records of the subscriber from the record storage device 330, and deploy such telecommunications records in the model device 332, where the records can be processed using the installed fraud model to produce a model output signal.

In various embodiments, the fraud model can produce a variety of outputs. For example, in a first embodiment, a fraud model can output a generally continuous numerical signal. For example, a fraud model servicing a particular subscriber might output a real number from 0.0 to 1.0 (or an integer ranging from 0 to 100) to indicate the likelihood that a particular set of events amounted to callback fraud.

In other embodiments, the fraud model can output a discrete signal, e.g., 0 or 1, to indicated the presence or absence of a recorded event, a suspicious pattern of events or a set of suspicious circumstances. For example, a fraud model servicing a second particular subscriber might output a discrete 0/1 signal to indicate that a consumer has gained unauthorized access to a subscriber's services.

As a given fraud model generates its output, the threshold device 334 can access the model output signal and apply a number of applicable processes, e.g., filtering, transforms, accumulators etc., as well as apply a threshold operation to the model output signal.

For example, in a first embodiment where a fraud model generates a continuous signal, the threshold device 344 might apply a filter followed by a logarithmic transform followed by a comparison operation with a threshold.

In contrast where a fraud model generates a discrete 0/1 signal, the threshold device 344 might apply an accumulation process to count the number of events of interest over a particular time frame, then apply the accumulated output to a threshold.

In instances where the fraud model output signal exceeds the permissible bounds defined by the threshold, the threshold device 344 can send a signal to the alert device 360. In response, the alert device 360 can generate an “alert”, which for the present example can consist of a notification to an operator accompanied by various details, such as the particular subscriber affected, time, date, the nature of the fraud (e.g., callback fraud) and so on.

As the fraud detection system 220 continues to collect and process telecommunications records, the various alerts can be received by the alarm reporting device 370, where they can be grouped according to subscriber or otherwise appropriately organized. Periodically, the alarm reporting device 370 can then submit automated reports to an operator (not shown) via the input/output device 390.

While in some embodiments, each subscriber can have his own set of fraud models and thresholds with respective adaptive variables, it should be appreciated that it may be advantageous to apply the same fraud model and threshold paradigm to groups of subscribers while allowing adaptive variables to vary per subscriber. For example, a group of subscribers selling international calling cards might all be perfectly well served by the same callback fraud model and threshold paradigm, but due to the location of each subscriber's sales base the threshold parameters appropriate to one subscriber may ill-serve the other subscribers.

Returning to the fraud detection engine 340, it should be appreciated that there can be at least three types of fraud detection approaches of interest: single event monitoring, cumulative monitoring and per-usage monitoring.

Single event monitoring is simply where a fraud detection system seeks to detect every event or pattern of events of interest and generate an alert accordingly.

Cumulative monitoring is conceptually more complex than single event monitoring, and requires a number of concepts to understand; the first two being a “processing bucket” and a “rolling event window”. For example, in a first embodiment the fraud detection device 340 can review all relevant telecommunications records of the last ‘n’ days, e.g., 30 to 90 days, to form a “processing bucket” of data. The fraud detection device 340 may then need to perform a number of statistical operations to determine certain relevant data. For instance, the fraud detection device 340 might determine the mean, median, variance, standard deviation, maximum value and minimum value that a particular event occurred (based on a particular fraud model and 90 day processing bucket) over a three-hour window (or other given time period), the three-hour time period being the time for the “rolling event window”. Subsequently, the threshold of the threshold device 344 can then be set to look for all event of interest over the last three hours of usage for a subscriber. Should the number of events exceed the threshold, an alert can be generated.

For the example above, the particular value of a threshold can vary, but depending on circumstances a threshold advantageously might be set to the mean value of the time period, the mean value plus one standard deviation or the mean value plus two standard deviations and so on.

Once the threshold value is set, it should be appreciated that the threshold device 344 could periodically recursively reviewing the number of events of interest that have occurred in the last three hours at any given time and cause an alert whenever the number of events per three-hour period exceeds the proscribed threshold.

In contrast to a cumulative approach, a per-usage monitoring approach does not consider events over a set time period, but considers the number of events (or pattern of events) that might occur in a given usage, e.g., each telephone call from country A to country B. In such a situation an appropriate threshold might be set to the mean value plus two or three standard deviations or perhaps the maximum/minimum values with optional offset. Accordingly, the threshold device 344 could function by accumulating detected events, then determining whether the accumulated amount exceeds the threshold.

For example, a particular per-usage fraud detection technique might be based on detecting the number of times that a particular sequence of DTMF or other telecommunications control tones occurs. With a fraud model doing the detecting part of the task, the threshold device 344 could function by reviewing the number of tone sequences that have occurred during the call and instigate an alert whenever the number of tones exceeds the set threshold.

Returning to FIG. 3, as the fraud detection system 220 continues to collect and process telecommunications records, the adaptive portions of the fraud model and/or threshold paradigm can be periodically updated or allowed to remain static. In those embodiments where the adaptive portions of the fraud model and/or threshold paradigm are periodically updated, it should be appreciated that such continuous adaptation can occur as quickly as after every fraud determination or alternatively according to some predetermined schedule or upon operator command.

For example, for fraud detection schemes using an 90-day processing bucket, the fraud detection device 340 may create a new processing bucket every week. Subsequently, the fraud detection device 340 may determine the various statistical variables discussed above to update an adaptive threshold.

While threshold update may in some circumstances be automatic, it should be appreciated that in other circumstances such a continuously adapted threshold might be subject to a “tolerance factor.” That is, in certain circumstances where the threshold would be updated less than a small amount (the “tolerance factor”), the fraud detection device 340 would forgo any change. Use of a tolerance factor can serve to increase functional efficiency and also make a fraud detection system resilient to low level fluctuations often seen in a telecom usage environment

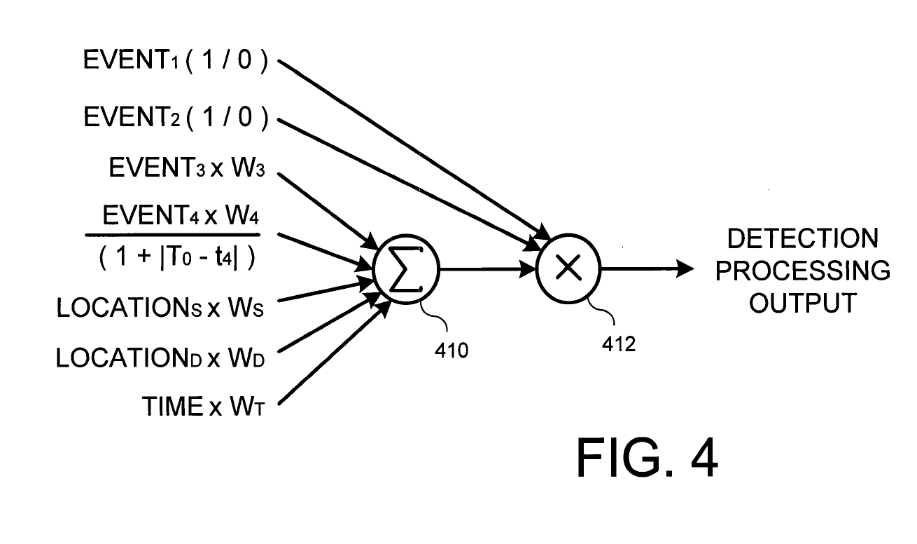

FIG. 4 depicts an exemplary telecommunications fraud detection model 400. As shown in FIG. 4, the exemplary fraud detection model 400 has a parametric form consisting of a number of events (determined from various telecommunications records), including a first set of events EVENT₁ and EVENT₂, that must occur (or must never occur) for a positive fraud detection, a second set of events, EVENT₃ and EVENT₄, that can be indicative, but not dispositive, of fraud, a source location LOCATION_{S}, a destination location LOCATION_{D} and a TIME variable. Further shown in FIG. 4, EVENT₃ is weighted according to weight W₃, and EVENT₄ is weighted according to weight W₄ as well as by a relative time difference |T₀−t₄|, (T₀—representing an determined time period and t₄ representing a measured time period) which can model potentially useful properties, such as conformity of a time between two events. Still further, adaptive weights W_{S}, W_{D} and W_{T} can be used to account for the propensity for fraud to occur based on location as well as time of day, week, month and/or year.

In operation, the various measured events, locations, time periods and times can be appropriately weighted and applied to the addition operator 410 and the multiplication operator 412 as indicated in FIG. 4. Accordingly, an output of the multiplication operator 412 will be produced for further processing. In circumstances where the fraud model 400 is made continuously adaptive, it should be appreciated that one or more of the various weights W₁ . . . W_{T} might be expected to periodically change.

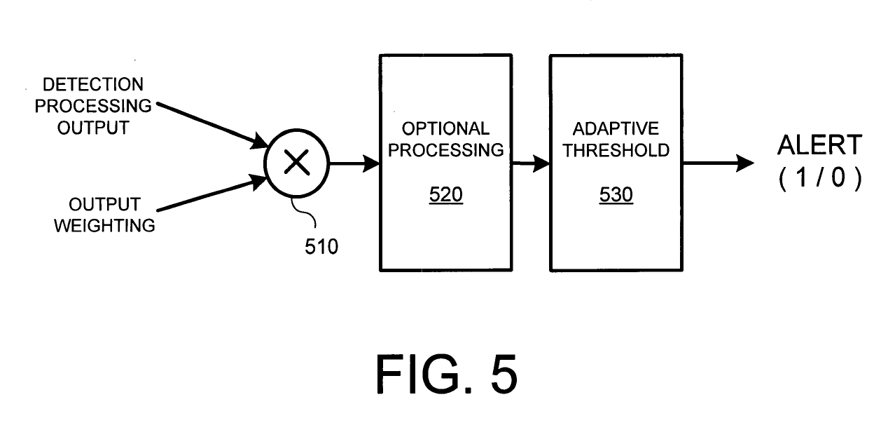

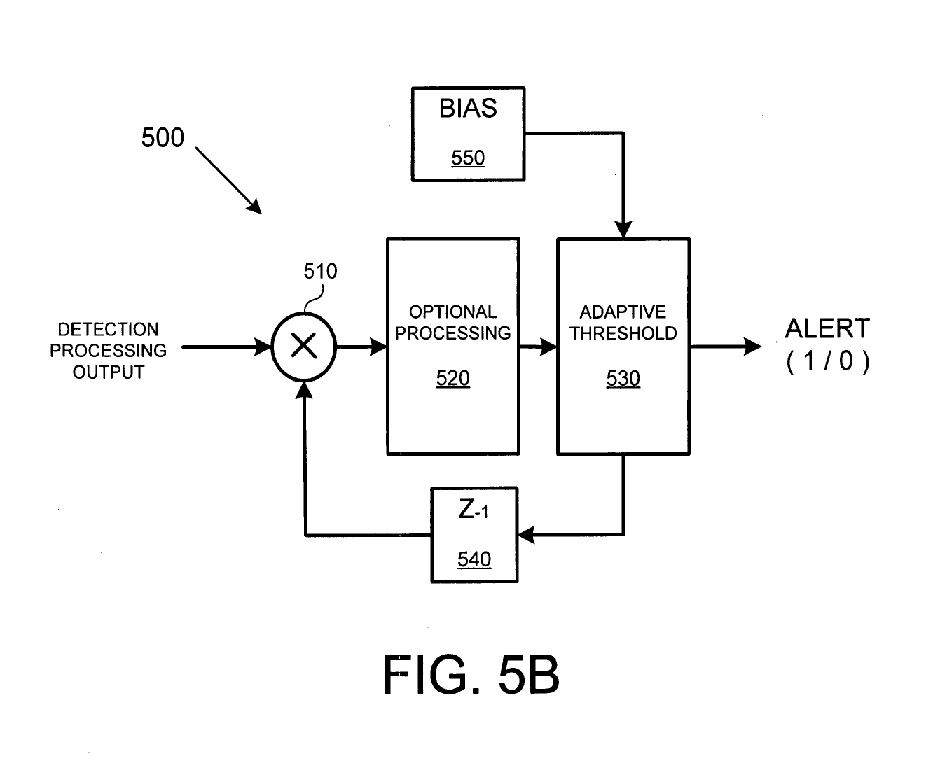

FIG. 5 depicts an exemplary adaptive threshold paradigm 500. As shown in FIG. 5, the exemplary threshold paradigm 500 includes an optional processing block 520, an adaptive threshold block 530 and a multiplication operator 510 that receives an output from a fraud detection model (such as the model shown in FIG. 4) as well as a feedback signal originating from the adaptive threshold block 530 and delayed by delay 540.

In operation, multiplication operator 510 can produce a product output based on the output of fraud detection model and feedback signal, and feed the product to the optional processing block 520. Subsequently, the optional processing block 520 can apply any number of appropriate and useful processes, such as a an accumulation process, a transform process, a filtering process, an adaptive process etc, and apply its processed output to the adaptive threshold block 530. The adaptive threshold block 530, in turn, can apply a threshold operation (continuously adaptive or not) to the output of processing block 520 to provide a discrete alert signal output indicating whether the permissible bounds of the fraud model are exceeded.

While certain functions of the exemplary threshold paradigm 500 might be re-ordered and placed in a fraud detection model, the particular example of FIG. 5 is provided in part to show that the interrelationship between a fraud model and threshold paradigm can be complex in various embodiments. However, as discussed above, it is envisioned that various embodiments can use much more simple processing to the point where only a single adaptive variable, placed in either a fraud model or threshold device, is used.

Further, while it should be appreciated that a fraud model/threshold paradigm combination can be structured to minimize the total number of errors, it should be appreciated that such a system might not be optimal under certain circumstances.

For instance, consider that there are two types of errors that a fraud management system can make: (1) mistake fraudulent activity for legitimate activity, and (2) mistake legitimate activity for fraudulent activity. In various embodiments where a fraud model/threshold paradigm combination is perfectly adapted system, the likelihood of each type of error may be equal.

While such an outcome of equally likely errors may be optimal in certain circumstances, in other situations such an outcome may pose unnecessary problems or sub-optimal outcomes. For example, it may be more beneficial to allow a small amount of extra fraud to occur in a telecommunications network in order to alleviate false fraud alerts that might lead to customer relations problems. However, in other embodiments it may be more beneficial to err on the side of having an excessive number of fraud alert errors in order to better police fraudulent activity at the expense of having to manually investigating false fraud alerts.

Referring now to FIG. 5B, a biasing device 550 is added to the threshold device 500 of FIG. 5 in order to accommodate the biasing issues discussed above. While the biasing device 550 is in the present circumstances a part of the threshold device 500, it should be appreciated that biasing may be introduced in a variety of ways, including by being built into a fraud model. For example, if the relative time difference |T₀−t₄| discussed above proves optimal in minimizing total error, a modified relative time difference |T′₀−t₄| might be used to reduce fraud alerts at the expense of allowing excessive fraud

In addition to tinkering with a continuously adaptive threshold by adding a bias, it may also./alternatively be advantageous to artificially limit the range of the threshold. For example, suppose that a threshold tends to vary about a range between 0 and 100. An operator may desire to create a lower limit of 20, an upper limit of 80 or both.

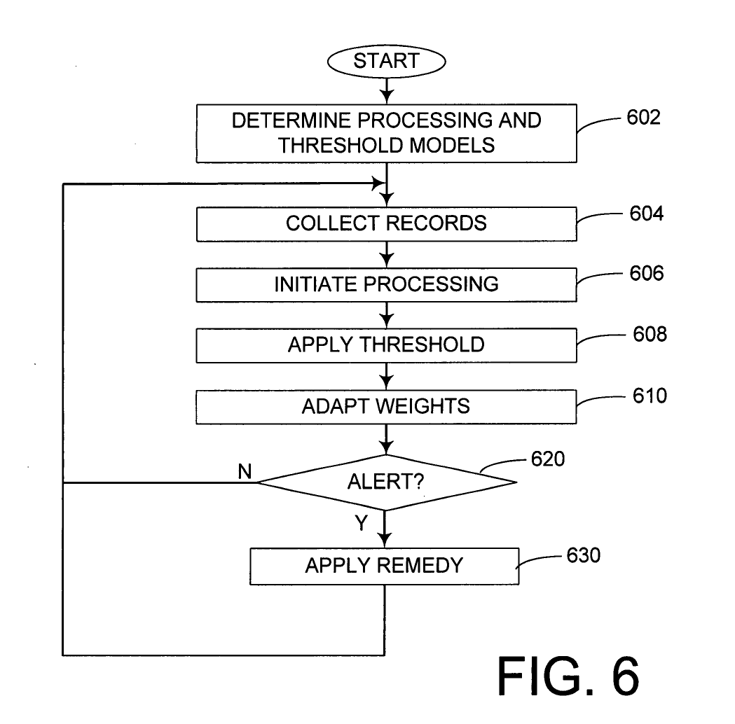

FIG. 6 is a flowchart outlining an exemplary operation according to the present disclosure for detecting telecommunications fraud in a telecommunications network for a specific subscriber or group of subscribers. The process starts in step 602 where an appropriate fraud detection model and threshold paradigm are selected. As discussed above, a fraud detection model can take any number of viable or useful forms, such as the exemplary parametric form shown in FIG. 4, and in various cases a fraud detection model can consist of multiple independent models. Similarly, the threshold paradigm can take any of variety of useful forms, such as that shown in FIG. 5, and in various cases a threshold paradigm can consist of multiple independent threshold paradigms servicing respective fraud detection models. Control continues to step 604.

In step 604, an initial number of telecommunications records relating to the specific subscriber (or group of subscribers) mentioned above are collected in order to establish a set of initial weights for the fraud detection model and/or threshold paradigm. Next, in step, 606, the adaptive weights/parameters for the fraud detection model and/or threshold paradigm are established. While the exemplary adaptive process for establishing and modifying adaptive weights is based on a processing bucket approach, as mentioned above any adaptive process, e.g., Newtonian, steepest descent, etc., useful for establishing and/or modifying adaptive weights can be used as may be desired, required or otherwise found useful. Control continues to step 608.

In step 608, an initial set of telecommunications records are collected for processing. Next, in step 610, the collected records are processed using the fraud model (or models). Then, in step 612, the output of each fraud model is applied to an appropriate threshold paradigm. Control continues to step 620.

In step 620, a determination is made as to whether an alert should be generated, i.e., whether the output of a fraud model has exceeded the permissible bounds defined by a respective threshold. If an alert should be generated, control continues to step 622; otherwise, control jumps to step 630.

In step 622, an appropriate remedy to the alert is applied, which as discussed above can take a variety of forms ranging from notification of one or more individuals to immediately cutting off a particular telecommunications exchange to possibly suspending a subscriber's access to a provider's equipment. Control continues to step 630.

In step 630, a determination is made as to whether to update the adaptive weights in the fraud detection model and/or threshold. If the weights are to be updated, control jumps back to step 606 where another adaptive process is applied to the relevant weights/parameters; otherwise, control jumps back to step 608 where a next set of telecommunications records are collected to be processed. The cycles of procedures defined by steps 606-630 can then continue as desired, or the entire process can be stopped as may be required or found advantageous, e.g., to apply a different fraud detection model or threshold paradigm.

In various embodiments where the above-described systems and/or methods are implemented using a programmable device, such as a computer-based system or programmable logic, it should be appreciated that the above-described systems and methods can be implemented using any of various known later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to fraud-detection related services.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for detecting telecommunications fraud for a telecommunications provider in a telecommunications network, the apparatus comprising:
a receiving device that receives telecommunications traffic information relating to one or more subscribers of a telecommunications provider; and
a fraud detection engine that determines whether telecommunications fraud has occurred based upon the received telecommunications traffic information;
wherein the fraud detection engine uses an adaptive process to determine fraud.

2. The apparatus of claim 1, wherein the fraud detection engine includes an adaptive threshold device configured to adaptively change at least one threshold based on past telecommunications traffic, wherein the threshold relates to an output of a fraud detection model.

3. The apparatus of claim 2, wherein the fraud detection engine further includes a fraud detection model device configured to process a fraud detection model, and provide an output of the fraud detection model to the adaptive threshold device.

4. The apparatus of claim 1, wherein the fraud detection engine includes a fraud detection model device configured to process a fraud detection model.

5. The apparatus of claim 5, wherein the detection model device includes at least one adaptive parameter, and wherein the detection model device periodically changes the adaptive parameter to enable the fraud detection engine to more advantageously detect telecommunications fraud.

6. The apparatus of claim 1, wherein the fraud detection engine is configured to detect fraud for multiple subscribers of the telecommunications provider.

7. The apparatus of claim 6, wherein the fraud detection engine is configured to use a separate adaptive system for different sets of subscribers of the telecommunications provider.

8. The apparatus of claim 6, wherein the fraud detection engine is configured to use a separate adaptive system for individual subscribers of the telecommunications provider.

9. The apparatus of claim 8, wherein the separate adaptive systems each include at least one of an adaptive model parameter or adaptive threshold, and wherein each adaptive model parameter or adaptive threshold being determined by telecommunications traffic relating to the respective individual subscribers of the telecommunications provider.

10. The apparatus of claim 8, wherein the separate adaptive systems each include at least one adaptive threshold relating to respective individual subscribers, and wherein the adaptive threshold being determined by telecommunications traffic relating to the respective individual subscribers.

11. The apparatus of claim 1, further comprising an alerting device configured to provide an operator a message whenever the fraud detection engine detects that a fraud model exceeds a fraud detection threshold.

12. The apparatus of claim 1, further comprising a number of telecommunications monitoring devices configured to monitor the telecommunications traffic information, and provide the telecommunications traffic information to the receiving device.

13. The apparatus of claim 12, further comprising a telecommunications network upon which the monitoring devices are coupled to and monitoring.

14. The apparatus of claim 1, wherein the fraud detection engine uses a separate adaptive process for each of two or more individual subscribers of the telecommunications provider to determine fraud.

15. A method for detecting telecommunications fraud in a telecommunications network, the method comprising:
receiving a plurality of first telecommunications traffic records relating to one or more subscribers of a telecommunications provider; and
performing a fraud detection operation on the first telecommunications traffic records using an adaptive fraud detection process.

16. The method of claim 15, wherein the step of performing a fraud detection operation includes executing an adaptive fraud detection model using the first telecommunications traffic records to produce a first model output, the adaptive fraud detection model being configured to be periodically updated based on earlier telecommunications traffic records.

17. The method of claim 16, further comprising the step of applying a threshold operation to the output of the first model output.

18. The method of claim 17, wherein the step of applying the threshold operation includes applying an adaptively derived threshold to produce a first alert.

19. The method of claim 15, wherein the step of performing a fraud detection operation includes:
executing a fraud detection model using the first telecommunications traffic records to produce a first model output, and
applying a threshold operation to the output of the first model output, wherein threshold operation includes applying an adaptively derived threshold to produce a first alert.

20. A method for detecting telecommunications fraud in a telecommunications network, the method comprising:
receiving a plurality of telecommunications traffic records relating to a plurality of subscribers of a telecommunications provider; and
performing a fraud detection operation on each of the plurality of subscribers using a respective combination of a fraud detection model and threshold paradigm selected for each subscriber, wherein each of the respective combinations includes at least one adaptive component;
wherein the adaptive component for each particular subscriber is updated based on telecommunications traffic records specifically relating to the particular subscriber's usage.

21. An apparatus for detecting telecommunications fraud in a telecommunications network, the apparatus comprising:
a storage device containing a plurality of telecommunications traffic records relating to one or more subscribers of a telecommunications provider; and
an adaptive fraud detection means for adaptively detecting telecommunications fraud based on the telecommunications traffic records.

22. A storage medium containing a number of instructions that when accessed by a computer can enable a user to perform a number of telecommunications fraud detection operations, the storage medium including:
a first set of one or more instructions configured to receive a plurality of telecommunications traffic records relating to a plurality of subscribers of a telecommunications provider; and
a second set of one or more instructions configured to perform a fraud detection operation on each of the plurality of subscribers using a respective combination of a fraud detection model and threshold operator selected for each subscriber, wherein each of the respective combinations includes at least one adaptive component, wherein the adaptive component for each particular subscriber is updated based on telecommunications traffic records specifically relating to the particular subscriber's usage.

23. An apparatus for detecting telecommunications fraud in a telecommunications network for a telecommunications provider, comprising:
a fraud detection engine having at least a first fraud detection model suitable for detecting at least one form of telecommunications fraud and at least one respective adaptive threshold paradigm;
wherein the fraud detection engine is configured to apply the first fraud detection model to a group of subscribers of the telecommunications provider, but wherein at least two subscribers are assigned different respective adaptive threshold paradigms having different adapted weights.

24. The apparatus of claim 23, wherein the fraud detection engine is configured to apply the first fraud detection model to a group of subscribers of the telecommunications provider, but wherein each subscriber of the group is assigned a different respective adaptive threshold paradigm each having a different set of adapted weights.

25. The apparatus of claim 23, wherein the fraud detection engine periodically updates at least one adaptive weight of the threshold paradigm based upon a processing bucket approach of recent telecommunications activity.

26. The apparatus of claim 25, wherein the fraud detection engine periodically updates at least one adaptive weight of the threshold paradigm based upon a processing bucket approach of recent telecommunications activity.

27. The apparatus of claim 26, wherein the fraud detection engine periodically updates at least one adaptive weight of the threshold paradigm subject to a tolerance factor.

28. The apparatus of claim 26, wherein the fraud detection engine periodically updates at least one adaptive weight of the threshold paradigm subject to a proscribed threshold range limit.

29. The apparatus of claim 23, wherein the fraud model and threshold paradigm operate based on a cumulative activity approach.

30. The apparatus of claim 23, wherein the fraud model and threshold paradigm operate based on a single event approach.

31. The apparatus of claim 23, wherein the fraud model and threshold paradigm operate based on a per-usage approach.
